(19) United States
(12) Patent Application Publication
(10) Pub. No.: US 2009/0107506 A1
(43) Pub. Date: Apr. 30, 2009

(54) MASK ASSEMBLY

(76) Inventors: Louis Javier Collazo, Pompano Beach, FL (US); Sanjay Chandran, Boca Raton, FL (US); Shara Hernandez, Davie, FL (US); Norman D. Castillo, Miramar, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(21) Appl. No.: 12/256,388

(22) Filed: Oct. 22, 2008

Related U.S. Application Data
(60) Provisional application No. 60/996,002, filed on Oct. 24, 2007.

(51) Int. Cl. A62B 18/02

(52) U.S. Cl. 128/206.21

(57) ABSTRACT

Embodiments of the present invention provide a device, system and method for providing mask assemblies for use in the treatment of respiratory conditions and in assisted respirations. In an embodiment of the invention, a respiratory mask assembly can include a mask shell assembly, an inlet connector, a mask cushion and an adjustable forehead support. The mask shell assembly can include a central shell body with an inlet aperture for receiving a delivered amount of gas, and a rear mating edge. The inlet connector can include at least one non-circular exhalation port and can be rotatably disposed around the inlet aperture of the central shell body. The mask cushion can have a front mating edge for attaching it to the central shell body. The adjustable forehead support can have an extension bar, at least one forehead pad, and at least one locking tab that can be coupled to the central shell body.

### BACKGROUND OF THE INVENTION

1. Statement of the Technical Field

The present invention relates to mask assemblies and to a cushion therefor, for example, for use in the treatment of respiratory conditions and in assisted respirations.

2. Description of the Related Art

Ventilation interfaces having a cushion that provides a seal with a user's face are used for various applications. One such application involves current treatments for obstructive sleep apnea syndrome.

Obstructive sleep apnea syndrome (commonly referred to as obstructive sleep apnea, sleep apnea syndrome, and/or sleep apnea) is a medical condition that includes repeated, prolonged episodes of cessation of breathing during sleep. During a period of wakefulness, the muscles of the upper part of the throat passage of an individual keep the passage open, thereby permitting an adequate amount of oxygen to flow into the lungs. During sleep, the throat passage tends to narrow due to the relaxation of the muscles. In those individuals having a relatively normal-sized throat passage, the narrowed throat passage remains open enough to permit an adequate amount of oxygen to flow into the lungs. However, in those individuals having a relatively smaller-sized throat passage, the narrowed throat passage prohibits an adequate amount of oxygen from flowing into the lungs. Additionally, a nasal obstruction, such as a relatively large tongue, and/or certain shapes of the palate and/or the jaw of the individual, further prohibit an adequate amount of oxygen from flowing into the lungs.

An individual having the above-discussed conditions can stop breathing for one or more prolonged periods of time (e.g., ten seconds or more). The prolonged periods of time during which breathing is stopped, or apneas, are generally followed by sudden reflexive attempts to breathe. The reflexive attempts to breathe are generally accompanied by a change from a relatively deeper stage of sleep to a relatively lighter stage of sleep. As a result, the individual suffering from obstructive sleep apnea syndrome generally experiences fragmented sleep that is not restful. The fragmented sleep results in one or more of the following symptoms: excessive and/or inappropriate daytime drowsiness, headache, weight gain or loss, limited attention span, memory loss, poor judgment, personality changes, lethargy, inability to maintain concentration, and depression.

Other medical conditions can also prevent individuals, including adults and infants, from receiving an adequate amount of oxygen into the lungs. For example, an infant who is born prematurely can have lungs that are not developed to an extent necessary to receive an adequate amount of oxygen. Further, prior to, during and/or subsequent to certain medical procedures and/or medical treatments, an individual can be unable to receive an adequate amount of oxygen.

Under these circumstances, it is known to use a ventilation interface to apply a positive pressure to the throat of the individual, thereby permitting an adequate amount of oxygen to flow into the lungs. In known ventilation interfaces, oxygen and/or room air containing oxygen is delivered through the mouth and/or nose of the individual.

Existing types of positive pressure applied by the known ventilation interface include continuous positive airway pressure (CPAP), in which a positive pressure is maintained in the throat passage throughout a respiratory cycle, bi-Level positive airway pressure (BiPAP), in which a relatively high positive pressure is maintained during inspiration and a relatively low positive pressure is maintained during expiration, and intermittent mechanical positive pressure ventilation (IPPV) in which a positive pressure is applied when apnea is sensed (i.e., the positive airway pressure is applied intermittently or non-continuously).

Ventilation interfaces of ventilation systems include nasal masks and full masks, among others. For example, many nasal ventilation systems include a mask interface that fits over the nose of a user. The mask is intended to provide a space of gas (e.g., air) for inhalation into the lungs for respiration. Such systems, however, frequently suffer from gas leakage, creating an inability to assure proper ventilation in many users.

For example, some conventional masks incorporate a sealing surface that extends around the periphery of the mask. The sealing surface is often a molded or formed surface made from a resilient material including elastomers such as plastics, rubbers and foams. Such masks can perform well if the fit between the contoured sealing surface and the corresponding contours of the user's face is of high-quality.

Nevertheless, some users will have a least than optimal seal fit and gaps in the seal-to-face interface will occur. Often this is remedied by applying greater force to further compress the sealing surface against a user's face, thereby attaining a seal in those areas where the gaps occurred. This often produces user discomfort and may produce various types of skin irritation, particularly where the applied force exceeds the local perfusion pressure (e.g., the pressure that is sufficient to cut off surface blood flow).

Also, because many conventional ventilation systems use a headgear system having straps to bind the mask in place; the system is tightened to obtain a sufficient seal if one does not exist. The mask, headgear and/or individual straps thereby place greater pressure on the patient's face and/or head. Thus, discomfort to a patient can occur at places remote from the sealing surface.

Sealing problems causing discomfort are often exacerbated when the positive pressure of the gas being supplied is relatively high or is cyclical to high levels. The mask must be held against the face with a force sufficient to seal against leakage of the peak pressure of the supplied gas and as the gas pressure increases so does the needed force to prevent leakage.

Overall, user discomfort must be taken into consideration as it may well cause discontinued cooperation with the treatment regimen.

### SUMMARY OF THE INVENTION

Embodiments of the present invention address deficiencies of the art in respect to mask assemblies and provide a novel and non-obvious device, system and method for providing mask assemblies for use in the treatment of respiratory conditions and in assisted respirations. In an embodiment of the invention, a respiratory mask assembly can be provided. The respiratory mask assembly can include a mask shell assembly, an inlet connector, a mask cushion and an adjustable forehead support. The mask shell assembly can include a central shell body with an inlet aperture for receiving a delivered amount of gas, and a rear mating edge. The inlet connector can be rotatably disposed around the inlet aperture of the central shell body. The mask cushion can have a front mating edge for attaching it to the central shell body. The adjustable forehead support can have an extension bar with at least one locking tab that can be coupled to the central shell body.

In one aspect of the embodiment, the assembly can include a support interface attached to the central shell body that includes at least one adjustment slot and a support aperture, where the support aperture is configured to receive the extension bar and the at least one locking tab, and to engage the at least one locking tab of the extension bar with the at least one adjustment slot of the support interface.

In another preferred embodiment of the invention, a method for securing a forehead support and a central shell body in a respiratory mask assembly is provided. The method for securing a forehead support and a central shell body in a respiratory mask assembly can include providing a central shell body having a support interface with at least one adjustment slot, a support aperture, and a forehead support having an extension bar with at least a locking tab. The method further can include aligning the extension bar of the forehead support with respect to the aperture of the support interface for movement along a push-on direction, and, engaging the at least one locking tab of the extension bar with the at least one adjustment slot of the support interface to secure the forehead support to the central shell body.

In yet another preferred embodiment of the invention a forehead support of a nasal mask is provided. The forehead support can include an extension bar having an extension bar wall and at least one forehead pad that is connected to the extension bar. The forehead pad can include a first wall opposite a second wall, a third wall opposite a fourth wall and a pad wall connected to the first wall at a first end, the pad wall connected to the second wall at a second end, the pad wall connected to the third wall at a third end, and the pad wall connected to the fourth wall at a fourth. In one aspect of the embodiment, at least one of the pad wall, first wall, second wall, third wall and fourth wall can have a wall thickness less than a wall thickness of the extension bar wall.

In still yet another preferred embodiment of the invention a forehead support of a nasal mask is provided The forehead support can include an extension bar, a cross bar coupled to the extension bar and at least one forehead pad. The forehead pad can include a first wall opposite a second wall, a third wall opposite a fourth wall and a pad wall connected to the first wall at a first end, the pad wall connected to the second wall at a second end, the pad wall connected to the third wall at a third end, and the pad wall connected to the fourth wall at a fourth end. In one aspect of the embodiment, at least one of the pad wall, first wall, second wall, third wall and fourth wall can have a wall thickness less than a wall thickness of a wall of the cross bar.

In yet another preferred embodiment of the invention an inlet connector for a nasal mask assembly is provided. The inlet connector can include a conduit having a distal end and a proximate end opposite the distal end; and at least one non-circular exhalation port placed in the conduit. In one aspect of the embodiment, the conduit of the inlet connector can include at least one substantially circular exhalation port.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an exploded view of an exemplary mask assembly;

FIG. 2 is a perspective view of an exemplary mask assembly;

FIG. 3 is a side view of an exemplary mask assembly;

FIG. 4 is a front view of an exemplary mask assembly;

FIG. 5 is a top view of an exemplary mask assembly;

FIG. 6A is a side view of a first exemplary embodiment of a mask cushion;

FIG. 6B is a perspective view of a first exemplary embodiment of a mask cushion;

FIG. 6C is a front view of a first exemplary embodiment of a mask cushion;

FIG. 6D is a top end view of a first exemplary embodiment of a mask cushion;

FIG. 6E is a cross sectional view of a first exemplary embodiment of a mask cushion along the 6E-6E axis of FIG. 6C;

FIG. 6F is a cross sectional view of a first exemplary embodiment of a mask cushion along the 6F-6F axis of FIG. 6C;

FIG. 7A is a cross-sectional view of a second exemplary embodiment of a mask cushion;

FIG. 7B is a perspective view of a second exemplary embodiment of a mask cushion;

FIG. 7C is a top view of a second exemplary embodiment of a mask cushion;

FIG. 7D is an end view of a second exemplary embodiment of a mask cushion;

FIG. 7E is a cross sectional view of a second exemplary embodiment of a mask cushion along the 7E-7E axis of FIG. 7C;

FIG. 7F is a cross sectional view of a second exemplary embodiment of a mask cushion along the 7F-7F axis of FIG. 7C; and,

FIG. 7G is a rear view of a second exemplary embodiment of a mask cushion.

### DETAILED DESCRIPTION

Aspects of a mask assembly are disclosed in the following description and related drawings directed to specific embodiments of a mask assembly for use in the treatment of respiratory conditions and in assisted respirations. Alternate embodiments may be devised without departing from the spirit or the scope of the mask assembly. Additionally, well-known elements of exemplary embodiments of the mask assembly will not be described in detail or will be omitted so as not to obscure the relevant details of the mask assembly. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the mask assembly” does not require that all embodiments of the mask assembly include the discussed feature, advantage or mode of operation. In the drawings and in the description which follows, the term “proximal”, as is traditional will refer to the end of the device or apparatus which is closest to the individual or patient, while the term “distal” will refer to the end of the device or apparatus which is furthest from the individual or patient.

Embodiments of the present invention address deficiencies of the art in respect to mask assemblies and provide a novel and non-obvious device, method and system for providing a respiratory mask assembly for use in the treatment of respiratory conditions and in assisted respirations. In accordance with an embodiment of the present invention, a respiratory mask assembly can include a mask shell assembly, an inlet connector, a mask cushion and an adjustable forehead support. The mask shell assembly can include a central shell body with an inlet aperture for receiving a delivered amount of gas, and a rear mating edge. The inlet connector can be rotatably disposed around the inlet aperture of the central shell body. The mask cushion can have a front mating edge for attaching it to the central shell body. The adjustable forehead support can have an extension bar. The extension bar can have an extension bar wall having a wall thickness of about 0.2 mm to 10.0 mm. The extension bar can include a locking tab and at least one adjustment groove that can be coupled to the central shell body. The central shell body can include a support interface with at least one adjustment slot and a support aperture to couple to the adjustable forehead support. Embodiments of the mask assembly can be designed to cooperate with nearly any ventilation interface that makes use of a cushion for sealing engagement with portions of a user's face. For example, embodiments of the mask assembly can be designed to cooperate with nasal masks, oral masks, full masks and portions of hybrid masks (e.g., those masks having an oral cavity and either nasal inserts or nasal prongs) of various styles and shapes as will be appreciated by those having ordinary skill in the art.

In yet another preferred embodiment of the invention a forehead support of a nasal mask is provided. The forehead support can include an extension bar having an extension bar wall and at least one forehead pad, the forehead pad can include a first wall opposite a second wall, a third wall opposite a fourth wall and a pad wall connected to the first wall at a first end, the pad wall connected to the second wall at a second end, the pad wall connected to the third wall at a third end, and the pad wall connected to the fourth wall at a fourth. In one aspect of the embodiment, at least one of the pad wall, first wall, second wall, third wall and fourth wall can have a wall thickness less than a wall thickness of the extension bar wall. In yet another preferred embodiment of the invention a forehead support of a nasal mask is provided. The forehead support can include an extension bar having a cross bar and at least one forehead pad, the forehead pad can include a first wall opposite a second wall, a third wall opposite a fourth wall and a pad wall connected to the first wall at a first end, the pad wall connected to the second wall at a second end, the pad wall connected to the third wall at a third end, and the pad wall connected to the fourth wall at a fourth end. In one aspect of the embodiment, at least one of the pad wall, first wall, second wall, third wall and fourth wall can have a wall thickness less than a wall thickness of a wall of the cross bar. The cross bar can have a cross bar wall having a wall thickness of about 0.2 mm to 10.0 mm. In yet another preferred embodiment of the invention an inlet connector for a nasal mask assembly is provided. The inlet connector can include a conduit having a distal end and a proximate end opposite the distal end; and at least one non-circular exhalation port placed in the conduit. In one aspect of the embodiment, the conduit of the inlet connector can include at least one substantially circular exhalation port.

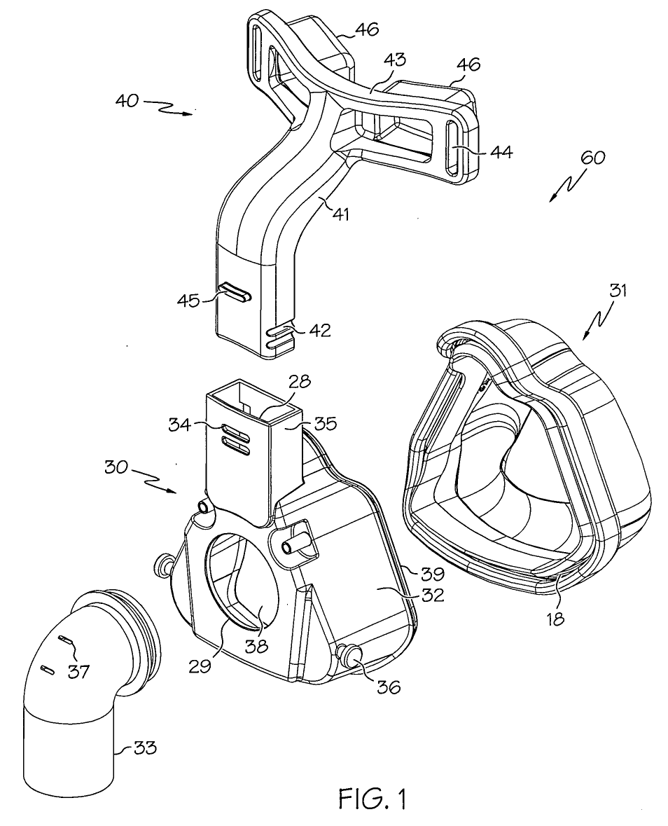

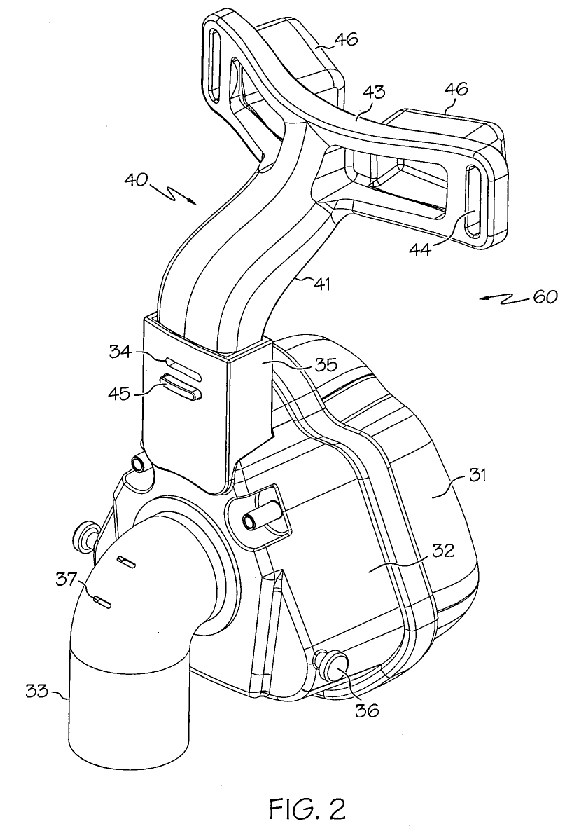

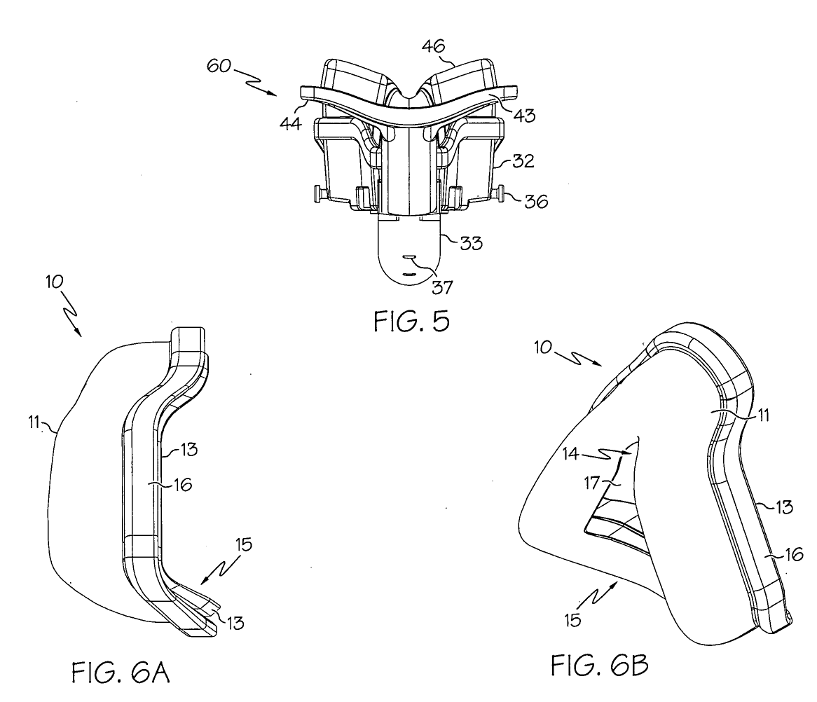

Referring to FIGS. 1-5, an exemplary embodiment of a mask assembly 60 can include a mask shell assembly 30 and a cushion 31. The mask shell assembly 30 can be made of a rigid material, for example a rigid plastic, which should be impermeable to gas or air. The mask shell assembly 30 can include a central shell body 32, an inlet connector 33 and a forehead support 40. Central shell body 32 can define a central cavity 38. An inlet aperture 29 in the front of the central shell body 32 can permit air to enter the center cavity 38. The inlet connector 33 can be rotatably coupled to the central shell body 32 so that it covers the inlet aperture 29. Inlet connector 33 can be located on a side opposite to cushion 31 or on a side of central shell body 32 that is substantially perpendicular to cushion 31, for example. In embodiments, the inlet connector can be attached to the front, top, bottom or sides of the central shell body 32. Alternatively, the inlet connector 33 also can be attached to the cushion 31.

Inlet connector 33 can have one or more exhalation ports 37. In embodiments, the inlet connector 33 can have at least two non-circular slots 37 which can be molded into the inlet connector 33. Non-circular slots 37 can have a cross-section that is constant, increasing or decreasing along the length of the slot 37. For example, instead of having a precise rectangular or square shape, the slots 37 can have a tapered rectangular or square shape. In this way, exhalation ports 37 can have a first cross-section at a first end of the slot 37 that can be larger than a second cross-section at a second end of the slot 37. In addition, the exhalation ports 37 can be tapered for a point downstream and of the entry portion of the exhalation port 37. In other words, cross-section of the entry portion of an exhalation port 37 can be larger (or smaller) than the cross-section of the exit portion an exhalation port 37 such that it provides a tapering of the exhalation port.

It is contemplated that circular and substantially circular exhalation ports 37 also can be provided and that a combination of non-circular ports and substantially circular ports can be used in combination. For example, inlet connector could have one substantially circular port, e.g., a circular hole and one non-circular port, e.g., a slit or slot. In addition, exhalation ports 37 can be located on various portions of the mask assembly 60, e.g., the central shell body 32, the cushion 21 and the inlet connector 33. In embodiments, the exhalation ports 37 can be plugged or omitted entirely for some applications, e.g., ventilation. In other embodiments, the exhalation ports 37 can be located on a separate part or insert (not shown) that can be assembled to the central shell body 32, the cushion 21 or the inlet connector 33.

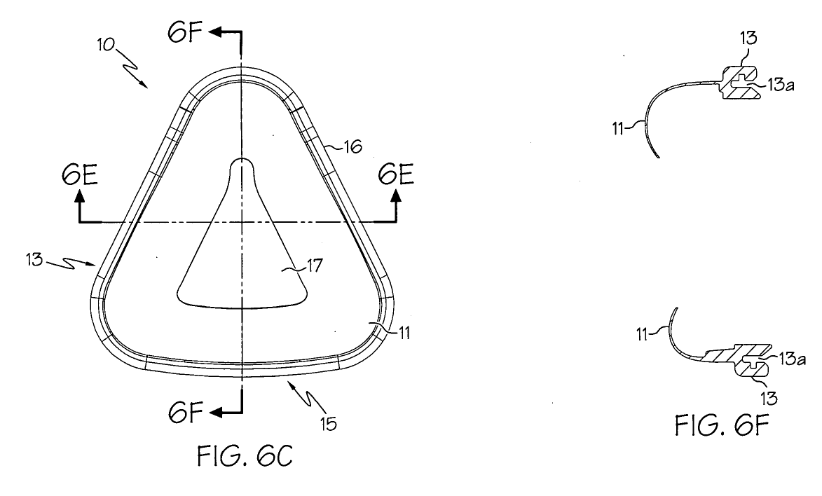

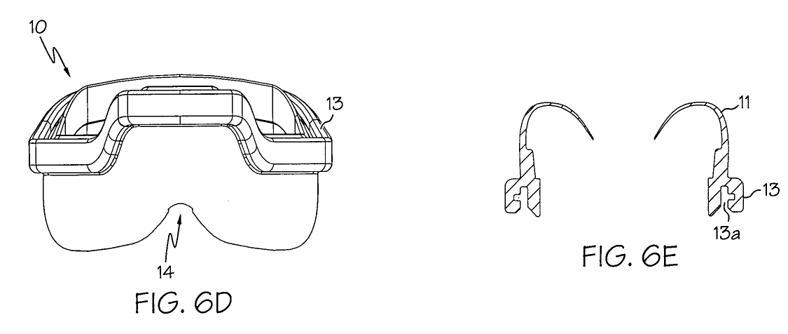

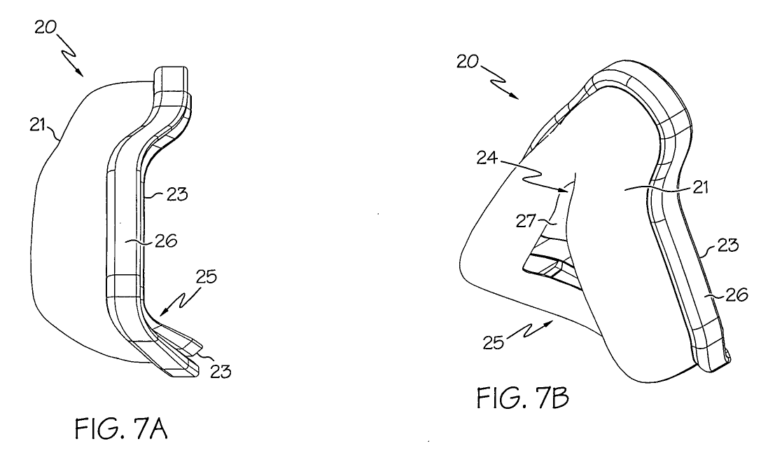

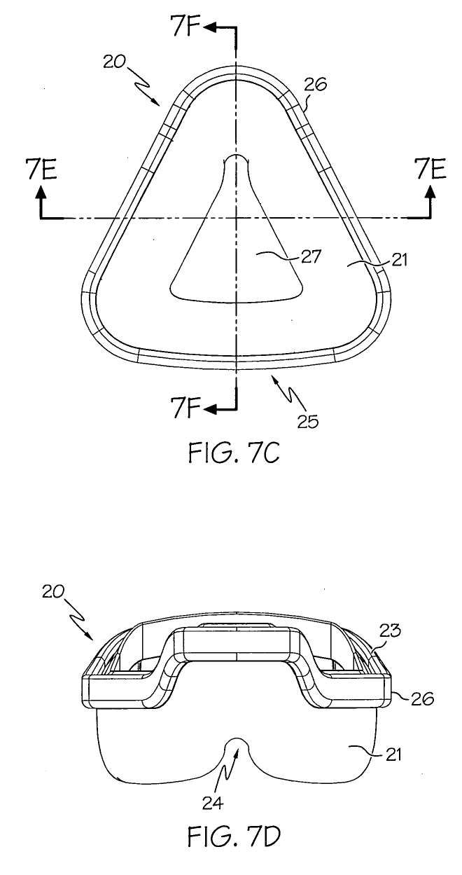

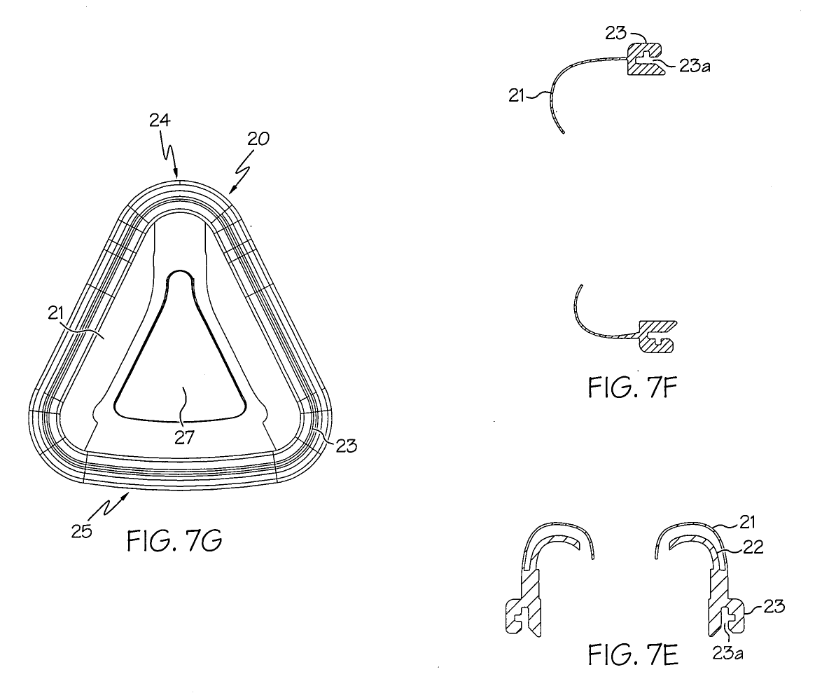

Central shell body 32 can include a mating edge 39 that can be mated to a corresponding mating edge 18, 13, 23 on mask cushion 31, 10, 20, shown in FIGS. 1, 6A-6D and 7A-7D, respectively. The mating of the mask cushion 31, 10, 20 to the central shell body 32 will be discussed in greater detail with reference to FIGS. 6A-6D and 7A-7D.

Mask shell assembly 30 can also include support interface 35, which can be integral to central shell body 32. In an exemplary embodiment of a mask shell assembly 30, forehead support 40 can be adjustably mounted to support interface 35 in a support aperture 28. For example, support aperture 28 can receive a distal end of extension bar 41 having adjustment grooves and locking tabs. As forehead support 40 is mounted to support interface 35, height adjustment grooves 42 can receive locking ridges (not shown) located within support aperture 28 of support interface 35. Support interface 35 can also have height adjustment slots 34 for receiving a locking tab 45 of forehead support 40. In other embodiments, the reverse configuration can be found. For example support interface 35 can have locking tabs 45, while extension bar 41 of forehead support 40 can have one or more height adjustment slots 34. In other embodiments, the support aperture 28 of support interface 35 can have one or more height adjustment grooves 42 and the extension bar 41 can have one or more locking ridges to mate with the adjustment grooves 42.

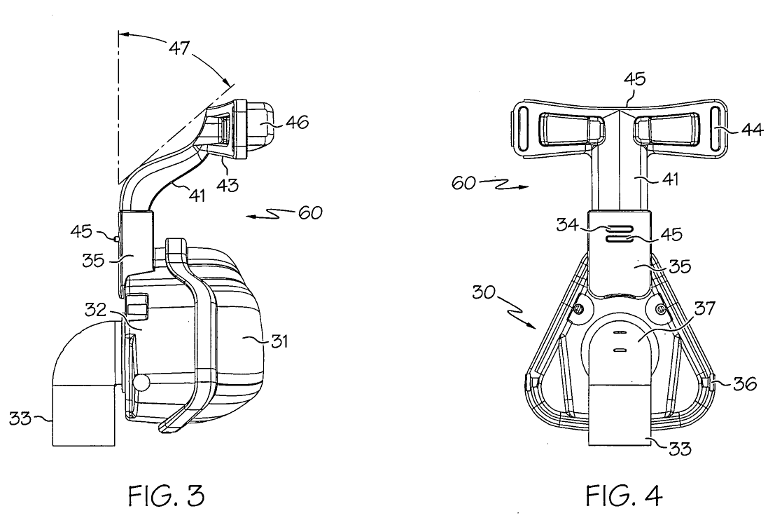

Forehead support 40 can include an extension bar 41 which can extend a cross bar 43 away from central shell body 32. The extension bar 41 can be at a preformed angle (γ) 47 to provide contact of the forehead pads 46 with the forehead of a user. In embodiments, the preformed angle can have a range of minus thirty (30) degrees to plus ninety (90) degrees. For example, the extension bar 41 can be formed at a seventy (70) degree angle (FIG. 3). Cross bar 43 can be extended to be placed substantially over a user's forehead. Cross bar 43 can include pads 46 which can be integral with cross bar 43 or removable. Forehead support 40 can add considerable comfort and stability to the use of mask assembly 60. In order to increase stability and comfort, the length of cross bar 43 and extension 41 can vary. For example, depending on the size of the user, cross bar 43 and extension 41 can be made longer or shorter.

In embodiments, the forehead support 40 can also be made of a unitary piece of flexible material, for example silicone elastomer, foam, gel, and other like materials, to permit the forehead support 40 to conform to different contours of a user's head. Forehead pads 46 can have a wall thickness in the range of 0.1 mm to 6.0 mm. In embodiments, the thickness of one wall of a forehead pad 46 can be less than half the thickness of another wall of the forehead pad 46. Alternatively, or in addition to, the thickness of one wall of a forehead pad 46 can be less than the thickness of other components of the mask shell, e.g., cross bar 43 or sealing membrane 21. In other embodiments, the forehead support 40 can be made of different materials. For example, extension 41 can be made of silicon, cross bar 43 can be made of rigid plastic and forehead pads 46 can be a gel or foam material. It is contemplated that the components of forehead support 40 can be made of any of the group of materials that includes silicon, rigid plastic, gel, foam and the like as known to one of skill in the art.

Slots 44 can be defined on terminating ends of cross bar 43 for receiving headgear fastening straps. Central shell body 32 can include connection points or slots 36 for receiving headgear fastening straps or quick-release buckles (not shown). The number and location of connection points 36 and slots 44 can vary according to desired comfort or stability. Central shell body 32, inlet connector 33 and quick-release buckle, can all be formed of a rigid plastic, for example, by conventional molding processes as is known to one having ordinary skill in the art. In embodiments, headgear (not shown) can be used to support the mask assembly 60 and create a seal with a user's face. Headgear can be attached to the mask shell assembly 30, cushion 31 or other component of mask assembly 60. In embodiments, the headgear can be an integrated or molded-in feature of the mask shell assembly 30, cushion 31 or other component of mask assembly 60.

Referring to FIGS. 6A-6F, mask cushion 10 is shown and can be mated to central shell body 32, shown in FIGS. 1-5, through coupling of cushion mating edge 13 and corresponding mating edge 39 on central shell body 32. For instance, mating edge 13 can be defined on substantially triangularly-shaped frame 16 of mask cushion 10. Correspondingly, the mating edge 39 on central shell body 32 can be a generally triangular portion, which can be generally perimetrical in nature as related to central shell body 32.

As one non-limiting example, mating edge 13 and the mating edge 39 of central shell body 32 can be either the female edge or the male edge of a tongue-and-groove attachment system. For example, mating edge 13 can be formed to include a grooved edge adapted to received a tongue (ridge) formed on the mating edge of central shell body 32. Additional mounting components such as a mounting ring (not shown) can be provided to more securely hold mating edge 13 and the mating edge of central shell body 32 in mating engagement. Alternatively, a barb (not shown) can be formed in the grooved edge of mating edge 13 to provide a more secure engagement. Regardless of the exact mating engagement, cushion 10 can be removably engaged with central shell body 32 to allow for replacement.

Cushion 10 can have a sealing membrane 11 and inner support rails 12. Sealing membrane 11 and inner support rails 12 can both extend from frame 16. Sealing membrane 11 can be thinner and more flexible than inner support rails 12. A portion of sealing membrane 11 can be a sealing portion that can be held against portions of a user's face when in use. For example, the sealing portion of sealing membrane 11 can be contoured to make contact with a user's face, when in use, proximate the bridge of the nose, around the cheeks, and proximate the skin between the upper lip and the base of the nose. Cushion 10 can have nasal bridge region 14 formed in a contoured fashion to receive the bridge of a user's nose.

In at least one exemplary embodiment, inner support rails 12 can run along the portions of cushion 10 that run along the sides of the user's nose. For example, the nasal bridge region 14 and upper lip region 15 cannot have any inner support rails 12. Inner support rails 12 can be more rigid than sealing membrane 11. Inner support rails 12 can also mimic the contours of the sealing membrane, which can contour the nose, upper lip and cheek regions. Inner support rails 12 can also have any other desired contour or shape independent of sealing membrane 11. Sealing membrane 11 and inner support rails 12 can extend from frame 16, which can be thicker and more rigid than both sealing membrane 11 and inner support rails 12.

The components of cushion 10 can be formed integrally by conventional molding processes. Cushion 10 can be more flexible than central shell body 32. Cushion 10 can also be resilient. For example, cushion 10 (and the components thereof) can be formed from an elastomeric material, such as a silicone elastomer. In embodiments, cushion 10 can have more than one membrane and/or be composed of multiple components. Cushion 10 could be a gel-style cushion or another style cushion as known in the art. In embodiments, cushion 10 can be assembled by press fitting the cushion 10 onto the central shell body 32. In embodiments, cushion 10 can be assembled in a non-removable fashion such as welding, bonding and the like, or the cushion 10 can be molded into one of the other components of mask assembly 60, e.g., mask shell assembly 30.

In at least one exemplary embodiment where the cushion 10 is formed from an elastomer, sealing membrane 11 can have a thickness of between about 0.35 and 0.55 mm. In another exemplary embodiment, inner rails 12 can have a thickness of between about 1.0 mm and 2.5 mm.

Sealing membrane 11 can be inwardly oriented. For example, sealing membrane 11 can extend from frame 16 and be curved inwardly where an outer edge generally defines an opening to nose-receiving cavity 17 within cushion 10 for receiving a user's nose. The outer edge of sealing membrane 11 can be adjacent a user's nose and can contact portions of a user's nose. In at least one exemplary embodiment, sealing membrane 11 can have a sealing portion for contacting portions of a user's nose that can generally run from (or be within) an outer edge of sealing membrane 11 up to portions of sealing membrane 11 that can overlap portions of inner support rails 12. The remainder (non-sealing portions) of sealing membrane 11 can face the atmosphere outside of cushion 10. In embodiments, the durometer range of cushion 10 can be ten (10) to eighty (80) Shore Type A durometer.

Inner support rails 12 can be also be inwardly oriented comparable to sealing membrane 11. Inner support rails 12 can extend from frame 16 and can be curved inwardly. Sealing membrane 11 and inner support rails 12 can be spaced (variably or constantly) from each other. Particularly, the inner surface of sealing membrane 11 and the outer surface of inner support rails 12 can be facing each other and can be spaced. Sealing membrane 11 and inner support rails 12 can be contoured in a variety of ways.

For example, sealing membrane 11 and inner support rails 12 can be differently contoured so as to be variably spaced when comparing cross-sections taken from different portions of cushion 10. Further, contouring of, for instance, sealing membrane 11 can have differing lengths as measured from the extension point at the intersection of membrane 11 and frame 16 to the outer edge of membrane 11. Thus, the outer edge of membrane 11 can be positioned further and, conversely, retracted when comparing cross-sections taken from different portions of cushion 10.

Inner support rails 12 may also have varying lengths and widths. For example, the width of inner support rails 12 can vary from the point of connection with frame 16 and the opposite inner-most edge. Additionally, the length, distance parallel with the sides of the user's nose, of inner support rails 12 can be shorter or longer.

When properly fitted on a user, a user's nose can be received in nose-receiving cavity 17 where the majority of a user's nose may enter past outer edge of sealing membrane 11. Portions (e.g., a sealing portion) of sealing membrane 11 can contact areas proximate a user's nose including proximate the bridge of the nose, around the cheeks, and proximate the skin between the upper lip and the base of the nose.

If mask shell assembly 30 is pressed sufficiently tight to a user's face proximate the user's nose, portions of sealing membrane 11 can be expected to deform into contact with portions of inner support rails 12. Inner support rails 12 can thus act as stoppers to hinder further deformation of sealing membrane 11. Particularly, the opposing curvatures of sealing membrane 11 and inner support rails 12 can aid in providing stopper functionality while maintaining comfort.

Also, inner support rails 12 can provide stopper functionality without unnecessarily interfering with portions of sealing membrane 11. Such decreased interference can provide greater freedom of movement to sealing membrane 11 that can maintain a space between sealing membrane 11 and inner support rails 12 under somewhat increased tensioning force at least at certain portions of cushion 10. Comfort can be maintained due to spacing between outer membrane 11 and inner support rails 12 even if nasal mask 32 is pressed more tightly than what may otherwise be considered optimal.

Indeed, users can apply excess pressure to mask shell assembly 30 when self-fitting even if less pressure would suffice (and be optimal) for various reasons, including lack of familiarity with such ventilation interfaces or simple fear of leakage. For instance, fear of leakage can lead a user to take measures that can sacrifice comfort for illusory security.

In another exemplary embodiment, referring to FIGS. 7A-7G, mask cushion 20 is shown and can be mated to central shell body 32, shown in FIGS. 1-5, through coupling of cushion mating edge 23 and corresponding mating edge 39 on central shell body 32. For instance, mating edge 23 can be defined on substantially triangularly-shaped frame 26 of mask cushion 20. Correspondingly, the mating edge 39 on central shell body 32 can be a generally triangular portion, which can be generally perimetrical in nature as related to central shell body 32.

As one non-limiting example, mating edge 23 and the mating edge of central shell body 32 can be either the female edge or the male edge of a tongue-and-groove attachment system. For example, mating edge 23 can be formed to include grooved edge 23a adapted to received a tongue (ridge) formed on the mating edge of central shell body 32. Additional mounting components such as a mounting ring (not shown) can be provided to more securely hold mating edge 23 and the mating edge of central shell body 32 in mating engagement. Alternatively, a barb (not shown) can be formed in grooved edge 23a to provide a more secure engagement. Regardless of the exact mating engagement, cushion 20 can be removably engaged with central shell body 32 to allow for replacement.

Sealing membrane 21 can be inwardly oriented. For example, sealing membrane 21 can extend from frame 26 and be curved inwardly where an outer edge generally defines an opening to nose receiving cavity 27 within cushion 20 for receiving a user's nose. The outer edge of sealing membrane 21 can be adjacent a user's nose and may contact portions of a user's nose. Frame 26 can be of uniform or varying thickness and can be contoured to a user's cheek and nose regions. Frame 26 can also be significantly thinner, from mating edge 23 to sealing membrane 21, in nose region 24 and upper lip region 25 as a means of effectively sealing these regions between the user and mask shell assembly 30.

Sealing membrane 21 can be contoured. For instance, sealing membrane 21 can have differing lengths as measured from the extension point at the intersection of membrane 21 and frame 26 to the outer edge of membrane 21. Thus, the outer edge of membrane 21 can be positioned further and, conversely, retracted when comparing cross-sections taken from different portions of cushion 20. In embodiments, a second sealing membrane 22 can be included in mask cushion 20. For example, as illustrated in FIG. 7E, the cross sectional view along axis A-A illustrates sealing membrane 21 and second sealing membrane 22 nested within sealing membrane 21. Both sealing membranes 21, 22 can be attached to mating edge 23 of cushion frame 26. In other embodiments, second sealing membrane 22 can be attached to sealing membrane 21.

The components of cushion 20 can be formed integrally by conventional molding processes. Cushion 20 can be more flexible than central shell body 32. Cushion 20 can also be resilient. For example, cushion 20 (and the components thereof) can be formed from an elastomeric material, such as a silicone elastomer.

Sealing membrane 21 can be thinner and thus more flexible than frame 26. In at least one exemplary embodiment where the cushion is formed from an elastomer, sealing membrane 21 can have a thickness of between about 0.35 and 2.5 mm.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

Therefore, the above-described embodiments should be regarded as illustrative rather than restrictive. Accordingly, it should be appreciated that variations to those embodiments can be made by those skilled in the art without departing from the scope of the nasal mask assembly as defined by the following claims.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

We claim:

1. A respiratory mask assembly comprising:
a mask shell assembly, the mask shell assembly including a central shell body, the central shell body including an inlet aperture for receiving a delivered amount of gas, the central shell body having a rear mating edge;
an inlet connector rotatably disposed around the inlet aperture of the central shell body;
a face cushion attached to the central shell body and having a front mating edge; and,
an adjustable forehead support coupled to the central shell body, the forehead support having an extension bar with at least one locking tab.

2. The system of claim 1, further comprising:
a support interface attached to the central shell body; the support interface including at least one adjustment slot and a support aperture, the aperture configured to receive the extension bar and the at least one locking tab, and to engage the at least one locking tab of the extension bar with the at least one adjustment slot of the support interface.

3. The system of claim 1, further comprising:
a support interface attached to the central shell body; the support interface including at least one locking ridge and a support aperture, the aperture configured to receive at least one adjustment groove of the extension bar, and to engage the at least one adjustment groove of the extension bar with the at least one locking ridge of the support interface.

4. The system of claim 1, wherein the inlet connector includes at least one exhalation port.

5. The system of claim 4, wherein the at least one exhalation port has a non-circular shape.

6. The system of claim 4, wherein the at least one exhalation port has a substantially rectangular shape.

7. The system of claim 4, wherein the at least one exhalation port has at least a first cross-section and a second cross-section, the first cross-section being greater than the second cross-section.

8. The system of claim 1, wherein the central shell body includes at least one exhalation port.

9. The system of claim 1, wherein the cushion includes at least one exhalation port.

10. The system of claim 1, wherein the adjustable forehead support is flexible, the forehead support bar providing a measured force to a forehead of a user.

11. The system of claim 1, wherein the extension bar is has a preformed angle.

12. The system of claim 11, wherein the preformed angle is in the range of minus thirty degrees to plus ninety degrees.

13. A forehead support for a mask assembly, the forehead support comprising:
an extension bar having an extension bar wall; and,
at least one forehead pad coupled to the extension bar, the at least one forehead pad includes a first wall opposite a second wall, a third wall opposite a fourth wall and a pad wall connected to the first wall at a first end, the pad wall connected to the second wall at a second end, the pad wall connected to the third wall at a third end, and the pad wall connected to the fourth wall at a fourth end, wherein at least one of the pad wall, first wall, second wall, third wall and fourth wall has a wall thickness less than a wall thickness of the extension bar wall.

14. A forehead support for a mask assembly, the forehead support comprising:
an extension bar;
a cross bar coupled to the extension bar; and,
at least one forehead pad coupled to the cross bar, the at least one forehead pad includes a first wall opposite a second wall, a third wall opposite a fourth wall and a pad wall connected to the first wall at a first end, the pad wall connected to the second wall at a second end, the pad wall connected to the third wall at a third end, and the pad wall connected to the fourth wall at a fourth end, wherein at least one of the pad wall, first wall, second wall, third wall and fourth wall has a wall thickness less than a wall thickness of a wall of the cross bar.

15. An inlet connector for a nasal mask assembly, the inlet connector comprising:
a conduit having a distal end and a proximate end opposite the distal end; and
at least one non-circular exhalation port placed in the conduit.

16. The inlet connector of claim 15, wherein the conduit includes at least one substantially circular exhalation port.

17. The inlet connector of claim 15, wherein the at least one non-circular exhalation port has at least a first cross-section and a second cross-section, the first cross-section being greater than the second cross-section.

18. The inlet connector of claim 15, wherein the at least one non-circular exhalation port has a substantially rectangular shape.

19. A method for securing a forehead support and a central shell body in a respiratory mask assembly, comprising:
providing a central shell body and a forehead support, the forehead support including an extension bar with at least one locking tab and the central shell body including a support interface with at least one adjustment slot and a support aperture;
aligning the extension bar of the forehead support with respect to the aperture of the support interface for movement along a push-on direction; and,
engaging the at least one locking tab of the extension bar with the at least one adjustment slot of the support interface to secure the forehead support to the central shell body.

20. The method of claim 19, further comprising:
engaging the at least one locking tab of the extension bar with one of a plurality of adjustment slots of the support interface to adjust a height of the forehead support with respect to the central shell body.
